(19) United States
(12) Patent Application Publication
(10) Pub. No.: US 2016/0019607 A1
(43) Pub. Date: Jan. 21, 2016

(54) DEVICE APPRAISAL

(71) Applicant: VERIZON PATENT AND LICENSING INC, Arlington, VA (US)

(72) Inventors: David BURMESTER, Columbia, MD (US); Wei-Ching LIN, Belle Mead, NJ (US)

(21) Appl. No.: 14/332,683

(22) Filed: Jul. 16, 2014

(51) Int. Cl. G06Q 30/02; H04W 8/24; H04W 4/00

(52) U.S. Cl. CPC G06Q 30/0278; H04W 4/008; H04W 8/24

(57) ABSTRACT

Systems and methods for device appraisal are described. Some implementations include receiving a request from a mobile station to access a device appraisal service, retrieving one or more parameters associated with the mobile station, where the parameters include at least a mobile directory number (MDN) of the mobile station, automatically determining a model of the mobile station based on the MDN, displaying, at the mobile station, a web interface of the device appraisal service, providing for display in the web interface an identification of the model of the mobile station and user interface elements to receive condition information of the mobile station, determining a trade-in value of the mobile station based on the identified model and the condition information, and providing the trade-in value of the mobile station to the web interface for display at the mobile station.

### BACKGROUND

In recent years, mobile device usage has significantly increased. With new phone models being made available at a rapid pace, consumers are eager to obtain new and improved device models. Often users will replace or trade-in their used devices for new devices. To allow the users to trade-in their devices wireless network providers have setup trade-in programs. To trade-in a device using such programs, users may need to visit a website associated with the trade-in program, indicate a model of their device, and describe a condition of their device before a quote for the value of the device is provided to the user by the website. If the appraised value of the device is acceptable to the user, the user may ship the used device to wireless network provider. The wireless network provider may then ship to the user a new device at a cost that is based on the appraised value of the shipped device. Alternatively, instead of visiting the website, the user may visit a physical store of the wireless network provider where the user may have the device manually appraised by a customer service agent. The user may then trade-in the device at the store if the appraised value is acceptable to the user.

Regardless of the trade-in scenario, the user needs to spend considerable time to have the device appraised for the device's trade-in value. This inconveniences the user and decreases likelihood of the user completing a trade-in for a new or improved device. From the wireless network provider's perspective, this may reduce a rate of adoption of new devices across the wireless network provider's user base.

As the foregoing illustrates, a new approach for device appraisal may be desirable.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is a high-level functional block diagram of an exemplary system of networks/devices that provide various communications for mobile stations and support an example of the device appraisal service.

FIG. 2 is an exemplary flow of operations via a web interface provided by an appraisal server at a mobile station.

FIG. 3 is a diagram including exemplary interfaces that can be used by a customer service agent to complete a trade-in process for the user of the mobile station.

FIG. 4 is a high-level functional block diagram of an exemplary non-touch type mobile station as may utilize the device appraisal service through a network/system like that shown in FIG. 1.

FIG. 5 is a high-level functional block diagram of an exemplary touch screen type mobile station as may utilize the device appraisal service through a network/system like that shown in FIG. 1.

FIG. 6 is a simplified functional block diagram of a computer that may be configured as a host or server, for example, to function as the appraisal server in the system of FIG. 1.

FIG. 7 is a simplified functional block diagram of a personal computer or other work station or terminal device.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The various implementations disclosed herein relate to device appraisal. The disclosed implementations allow a user of a mobile station to conveniently determine a trade-in value of the device at any time without contacting a customer service agent or even visiting a web site associated with a particular trade-in or mobile station recycling program. For example, the trade-in value may be automatically determined and displayed at the mobile station that is to be traded in by selecting a web link and providing responses to one or more mobile station condition questions. In another example, the trade-in value may be automatically determined and displayed by initiating or opening a mobile application or “app” provided on a mobile station. Because the trade-in value of the mobile station can be determined at any time without visiting a store of the wireless network provider or even visiting a separate website associated with a trade-in service, the disclosed implementations save user time and enhance user experience. Furthermore, users can receive immediate monetary rewards for their current mobile stations. The trade-in value of their current phone can be automatically applied to a new mobile station(s) or accessories. Overall, the disclosed implementations result in an increased likelihood of mobile station trade-in. This provides wireless network providers with new opportunities to upsell mobile stations, accessories and data plans.

Reference now is made in detail to the examples illustrated in the accompanying drawings and discussed below.

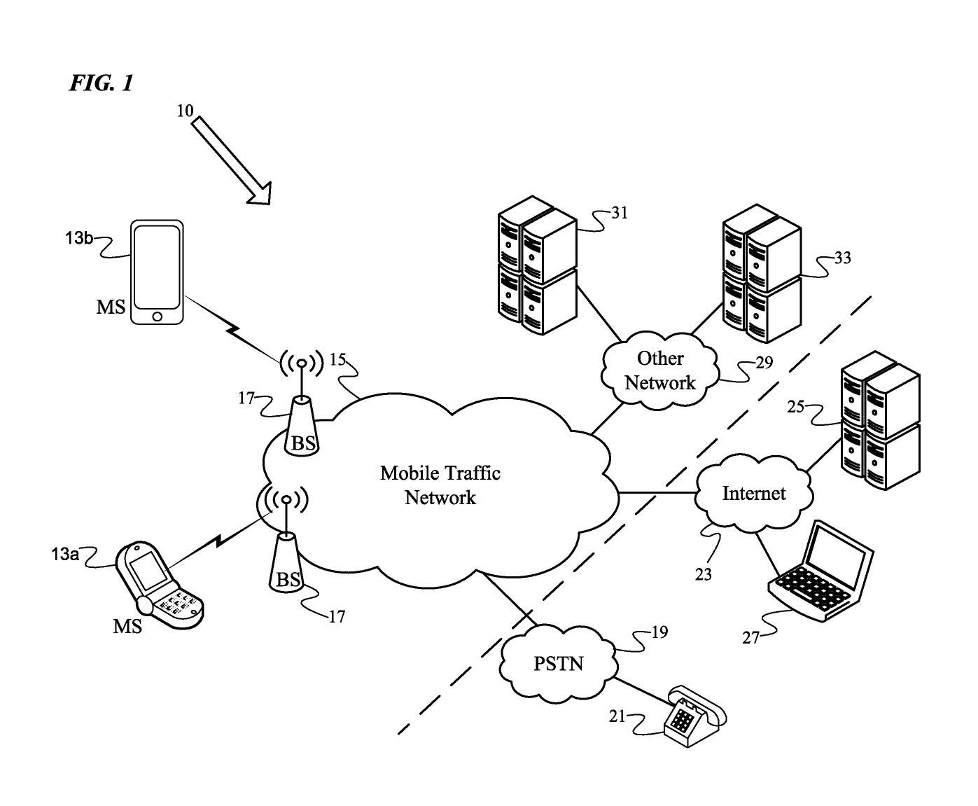

FIG. 1 is a high-level functional block diagram of an exemplary system 10 of networks/devices that provide various communications for mobile stations and support an example of the device appraisal service. The example shows simply two mobile stations (MSs) 13a and 13b as well as a mobile communication network 15. The stations 13a and 13b are examples of mobile stations that may be used for the device appraisal service. However, the network will provide similar communications for many other similar users as well as for mobile devices/users that do not participate in the device appraisal service. The network 15 provides mobile wireless communications services to those stations as well as to other mobile stations (not shown), for example, via a number of base stations (BSs) 17. The present techniques may be implemented in any of a variety of available mobile networks 15 and/or on any type of mobile station compatible with such a network 15, and the drawing shows only a very simplified example of a few relevant elements of the network 15 for purposes of discussion here.

The wireless mobile communication network 15 might be implemented as a network conforming to the code division multiple access (CDMA) IS-95 standard, Long Term Evolution (LTE), the 3rd Generation Partnership Project 2 (3GPP2) wireless IP network standard or the Evolution Data Optimized (EVDO) standard, Personal Area Network (PAN) network via Wi-Fi, the Global System for Mobile (GSM) communication standard, a time division multiple access (TDMA) standard or other standards used for public mobile wireless communications. The mobile stations 13 are capable of voice telephone communications through the network 15, and for the device appraisal service, the exemplary devices 13a and 13b are capable of data communications through the particular type of network 15 (and the users thereof typically will have subscribed to data service through the network).

The network 15 allows users of the mobile stations such as 13a and 13b (and other mobile stations not shown) to initiate and receive telephone calls to each other as well as through the public switched telephone network or “PSTN” 19 and telephone stations 21 connected to the PSTN. The network 15 typically offers a variety of data services via the Internet 23, such as downloads, web browsing, email, etc. By way of example, the drawing shows a laptop PC type user terminal 27 as well as a server 25 connected to the Internet 23; and the data services for the mobile stations13 via the Internet 23 may be with devices like those shown at 25 and 27 as well as with a variety of other types of devices or systems capable of data communications through various interconnected networks. The mobile stations 13a and 13b of users of the device appraisal service also can receive and execute applications written in various programming languages, as discussed further.

Mobile stations 13a and 13b can take the form of portable handsets, smart-phones or personal digital assistants, although they may be implemented in other form factors. Program applications, including an application to assist in the device appraisal service and/or an application provided via the on-line device appraisal service can be configured to execute on many different types of mobile stations 13a and 13b. For example, a mobile station application can be written to execute on a binary runtime environment for mobile (BREW-based) mobile station, a Windows Mobile based mobile station, Android, I-Phone, HTMLS, Java Mobile, or RIM based mobile station such as a BlackBerry or the like. Some of these types of devices can employ a multi-tasking operating system.

The mobile communication network 10 can be implemented by a number of interconnected networks. Hence, the overall network 10 may include a number of radio access networks (RANs), as well as regional ground networks interconnecting a number of RANs and a wide area network (WAN) interconnecting the regional ground networks to core network elements. A regional portion of the network 10 serving mobile stations 13a and 13b can include one or more RANs and a regional circuit and/or packet switched network and associated signaling network facilities.

Physical elements of a RAN operated by one of the mobile service providers or carriers include a number of base stations represented in the example by the base stations (BSs) 17. Although not separately shown, such a base station 17 can include a base transceiver system (BTS), which can communicate via an antennae system at the site of base station and over the airlink with one or more of the mobile stations 13a and 13b, when the mobile stations are within range. Each base station can include a BTS coupled to several antennae mounted on a radio tower within a coverage area often referred to as a “cell.” The BTS is the part of the radio network that sends and receives RF signals to/from the mobile stations 13a and 13b that are served by the base station 17.

The radio access networks can also include a traffic network represented generally by the cloud at 15, which carries the user communications and data for the mobile stations 13a and 13b between the base stations 17 and other elements with or through which the mobile stations communicate. The network can also include other elements that support functionality other than device-to-device media transfer services such as messaging service messages and voice communications. Specific elements of the network 15 for carrying the voice and data traffic and for controlling various aspects of the calls or sessions through the network 15 are omitted here form simplicity. It will be understood that the various network elements can communicate with each other and other aspects of the mobile communications network 10 and other networks (e.g., the public switched telephone network (PSTN) and the Internet) either directly or indirectly.

The carrier will also operate a number of systems that provide ancillary functions in support of the communications services and/or application services provided through the network 10, and those elements communicate with other nodes or elements of the network 10 via one or more private IP type packet data networks 29 (sometimes referred to as an Intranet), i.e., a private networks. Generally, such systems are part of or connected for communication via the private network 29. A person skilled in the art, however, would recognize that systems outside of the private network could serve the same functions as well. Examples of such systems, in this case operated by the network service provider as part of the overall network 10, which communicate through the intranet type network 29, include one or more application servers 31 and a related authentication server 33 for the application service of server 31.

A mobile station 13a or 13b communicates over the air with a base station 17 and through the traffic network 15 for various voice and data communications, e.g. through the Internet 23 with a server 25 and/or with application servers 31. If the mobile service carrier offers the device appraisal service, the service may be hosted on a carrier operated application server 31, for communication via the networks 15 and 29. Alternatively, the device appraisal service may be provided by a separate entity (alone or through agreements with the carrier), in which case, the service may be hosted on an application server such as server 25 connected for communication via the networks 15 and 23. Server such as 25 and 31 may provide any of a variety of common application or service functions in support of or in addition to an application program running on the mobile stations 13a and 13b. However, for purposes of further discussion, we will focus on functions thereof in support of the mobile device appraisal service. For a given service, including the device appraisal service, an application program within the mobile station 13a or 13b may be considered as a ‘client’ and the programming at 25 or 31 may be considered as the ‘server’ application for the particular service. As used herein the term appraisal refers to appraising a value (e.g., a monetary value) of any device, including, but not limited to, a mobile device. It is to be appreciated that the disclosed implementations are not limited to mobile devices and can be applied to any other devices or products.

To insure that the application service offered by server 31 is available to only authorized devices/users, the provider of the application service also deploys an authentication server 33. The authentication server 33 could be a separate physical server as shown, or authentication server 33 could be implemented as another program module running on the same hardware platform as the server application 31. Essentially, when the server application (server 31 in our example) receives a service request from a client application on a mobile station 13a or 13b, the server application provides appropriate information to the authentication server 33 to allow server application 33 to authenticate the mobile station 13a or 13b as outlined herein. Upon successful authentication, the server 33 informs the server application 31, which in turn provides access to the service via data communication through the various communication elements (e.g. 29, 15 and 17) of the network 10. A similar authentication function may be provided for device appraisal service(s) offered via the server 25, either by the server 33 if there is an appropriate arrangement between the carrier and the operator of server 25, by a program on the server 25 or via a separate authentication server (not shown) connected to the Internet 23.

In some implementations, to receive a trade-in value of the mobile station 13a, a user of the mobile station 13a may dial a phone number associated with a device appraisal service. The phone number may be an abbreviated number including special characters and/or letters. In another implementation, the user may send a text message to the phone number instead of making a call to the phone number. In yet another implementation, the user may select an app on the mobile station 13a to initiate a request to have the mobile station 13a appraised by the appraisal server 25. The app may be an appraisal app provided by a wireless network provider associated with the device appraisal server 25. The appraisal app may be pre-installed on the mobile station 13a or may be downloaded by the user at any time from the appraisal server 25.

In some implementations, when the user of the mobile station 13a dials the phone number of the device appraisal service, selects an appraisal app or sends a messaging service message (e.g., Short Message Service (SMS)) to the phone number, the device appraisal server 25 receives a request from the mobile station 13a. When an abbreviated phone number is used by the user, the abbreviated number (or a vanity number) may be first translated by a wireless network provider to a conventional phone number. Abbreviated dialing is the use of a short or abbreviated phone to reach services provided by a wireless network provider. An abbreviated phone number may, for example, include two or three digits. The abbreviated phone number may include alphanumeric characters such as “*” or “#” with numeric digits or alphabets (e.g., **SERV or **BANK, etc.) Also, upon receipt of the call, message, or app selection, the appraisal server 25 can receive one or more parameters associated with the mobile station 13a. The parameters include at least a mobile directory number (MDN) of the mobile station 13a. The parameters may also include, but are not limited to, an Electronic Serial Number (ESN) of the mobile station 13a and an International Mobile Station Equipment Identity (IMEI) of the mobile station 13a. The appraisal server 25 transmits the retrieved parameters including the MDN to a messaging server 31 that is configured to generate messaging service messages (e.g., SMS messages) for the device appraisal service to the MDN.

The appraisal server 25 may then provide a request to the user (e.g., via an automated phone call or messaging service message) to confirm enrollment in the device appraisal service and seek approval to receive a messaging service message from the device appraisal service. For example, an automated voice provided via an Interactive Voice Response (IVR) system may ask the user to press a particular button on the mobile station 13a to enroll in the device appraisal service. For example, the voice may ask the user to press “1” or “#” to confirm enrollment in the device appraisal service. In some implementations, the request may be sent to mobile station 13a (from where a call originates) or may be sent to another device. In some implementations, a call may originate from the mobile station 13a, however, a user may confirm enrollment via another device (e.g., mobile station 13b) that may be known to be associated via an account lookup pairing the devices. In this scenario, a different MDN (e.g., an MDN associated with mobile station 13b) may be provided to the appraisal server 25.

When the user selects the appropriate button (e.g., “1” or “#”) or combination of buttons to confirm enrollment via IVR, the appraisal server 25 receives a confirmation from the mobile station 13a. The appraisal server 25 provides the confirmation (e.g., a network message including mobile station 13a or 13b's MDN) to the messaging server 31. The confirmation indicates to the messaging server 31 that the mobile station 13a is ready to receive a messaging service message from the messaging server 31. The messaging server 31 then transmits to the MDN of the mobile station 13a (or mobile station 13b that may be associated with the same user account) the messaging service message including a link to access the web interface of the device appraisal service. The messaging service message may be first transmitted by the messaging server 31 to a Short Message Peer to Peer (SMPP) gateway of a wireless network provider servicing the mobile station 13a. From the SMPP gateway, the messaging service message may be transmitted to a Short Message Service Center (SMSC) and over a Radio Access Network (RAN) of the wireless network provider to the mobile station 13a.

In some implementations, when the link provided by the messaging server 31 is accessed (e.g., selected by a user) on the mobile station 13a, the appraisal server 25 can automatically determine at least a model of the mobile station. In some implementations, the appraisal server 25 can automatically determine a model of the mobile station (regardless of link selection or even without a link) after receipt of the MDN from the mobile station 13a. The model may be automatically determined using parameters that were retrieved from the mobile station 13a when the user first dialed the device appraisal service. In some implementations, the model can be retrieved from a database residing at the appraisal server 25 that stores associations between MDNs and device models. The appraisal server 25 can then provide for display in the web interface an identification of the model of the mobile station 13a and one or more user interface elements to receive condition information of the mobile station.

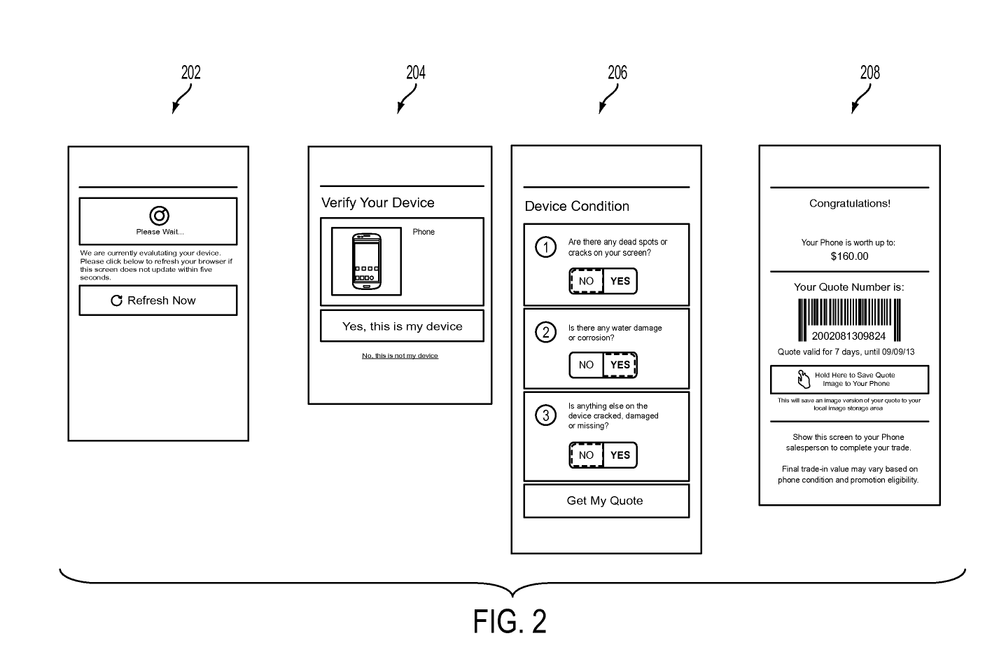

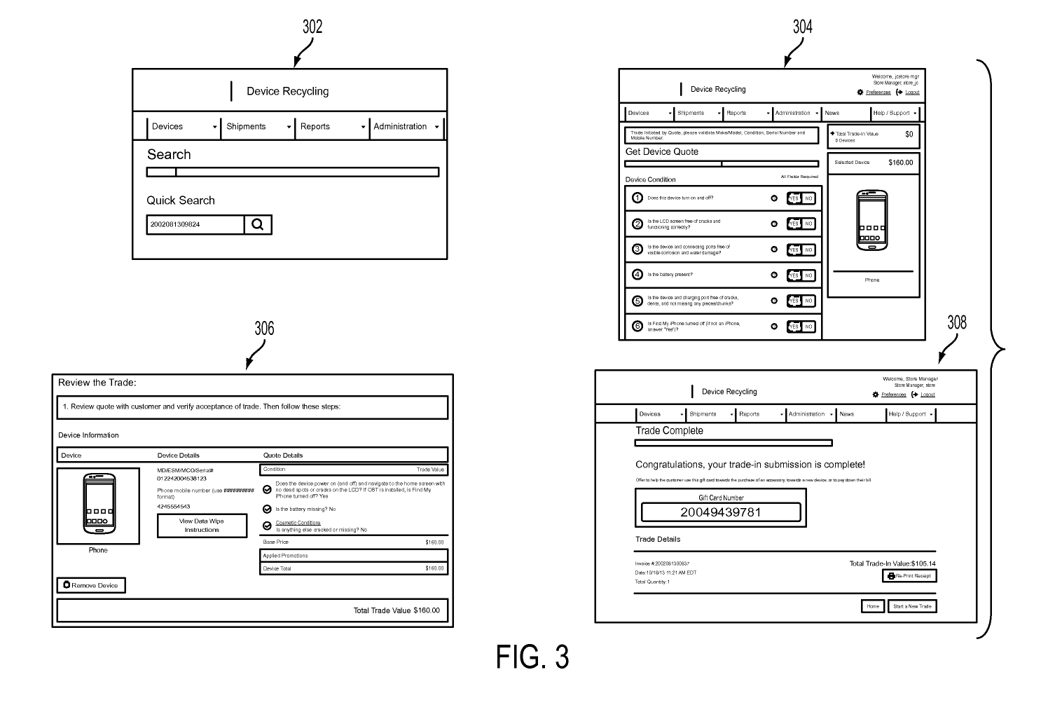

Upon receiving the condition information of the mobile station 13a, the appraisal server 25 determines a trade-in value of the mobile station 13a based on the identified model and the condition information. The appraisal server 25 then provides the trade-in value of mobile station 13a to the web interface for display at the mobile station 13a. The appraised value may be determined by the appraisal server 25 based on the condition of the mobile station 13a. In some implementations, the appraisal server 25 may automatically connect with a third-party device appraisal service to determine a trade-in value of the mobile station 13a. The condition of the mobile station 13a may be determined based on one or more inputs provided by the user of the mobile station 13a. These inputs are discussed below with respect to FIGS. 2 and 3.

FIG. 2 illustrates an exemplary flow of operations via the web interface provided by the appraisal server 25 at the mobile station 13a. User interface 202 can be displayed when the user has selected the link in the messaging service message provided by the messaging server 31. User interface 202 may also be displayed when the user selects an appraisal app on the mobile station 13a. User interface 202 indicates to the user that the appraisal server 25 is currently evaluating the mobile station 13a. In the background, the appraisal server 25 may automatically determine at least a model of the mobile station 13a. The appraisal server 25 can provide for display in the web interface an identification of the model of the mobile station 13a on user interface 204. User interface 204 can also include user interface elements to allow the user to confirm if the displayed device model is correct (e.g., “Yes, this is my device”). If the displayed device model is determined by the user to be incorrect, the user may select “No, this is not my device.” The user may then be provided with options to enter a correct device model of the mobile station 13a.

When the user has approved the displayed model of the mobile station 13a, a user interface 206 is provided for display to the user by the appraisal server 25. The user interface 206 may include questions regarding the condition of the device. The questions may be questions related to a visual display, electronics hardware, mechanical quality and any other aspects of the mobile station 13a. For example, the questions may include “Are there any dead spots or cracks on your screen?”, “Is there any water damage or corrosion?”, “Is there anything else on the device cracked, damaged or missing?” Adjacent to the questions, the user may be provided with “Yes or No” selection buttons that allow the user to provide responses to the questions. In this way, the user need not provide or type descriptive responses to the questions. In some implementations, a user may be permitted to provide descriptive responses and a text parser at the appraisal server 25 may automatically determine characteristics of the user's response and condition of the mobile station 13a based on the response. Once the user has selected the “Yes or No” responses via the selection buttons, the user may select the “Get My Quote” button to cause display of a trade-in value of the mobile station 13a. In some implementations, the user may not need to answer any questions because the physical condition of the mobile station 13a may be automatically determined (or approximated) by the appraisal server 25 based on an age of the mobile station 13a. The age of the mobile station 13a may be determined by the appraisal server 25 based on a first date of sale the particular mobile device for which the user is providing the responses noted above. In this scenario, where the condition of the mobile station 13a is approximated, the user interface screen 206 may not be displayed to the user and the trade-in value of the device may be directly displayed at any time before or after interface 204. This may further enhance user experience. In some implementations, when a user answers a particular question as a “Yes,” a deduction is made to the appraised value of the mobile station 13a. The deduction may be made based on a database of device types, quality conditions and predetermined deductions that may need to be made for each different type of quality condition for a particular mobile station type/model. The database may be prepopulated by one or more employees (e.g., device return team) of the wireless network provider. In some implementations, the appraisal server 25 has an initial or default value that assumes that the mobile station 13a is in good electronic and/or mechanical condition, is not customized or tampered with by the user, and has not had any core communication issues. In some implementations, each model of the mobile station 13a may have default values that are unique to each year, make, and model of the mobile station 13a that is used in trade-in value appraisal by the appraisal server 25. Hence, the adjustments made on account of mobile station damage are made in the context of that specific mobile station type as opposed to any mobile station in general. For example, a cracked screen would have a higher proportionate impact on the value of a late model iPhone than it would on a fifteen year old Motorola handset.

A user interface 208 can be provided by the analytics server 25 to the mobile station 13a to display a trade-in value for the mobile station 13a. The trade-in value may be displayed as a “dollar” amount or in any other currency. The currency may be automatically determined based on the geographic location and country associated with the mobile station 13a. A quote number associated with the trade-in value may also be displayed in the user interface 208. The quote number may uniquely identify a trade-in value/proposal for a particular device. The quote number may be encoded as a bar code (e.g., 2D or 3D barcode), quick response (QR) code(s) or provided via non-visual short range or near field communication (NFC) by the appraisal server 25. The quote may be valid for a particular time frame. For example the quote may be valid for a particular number of days from when the quote was generated and displayed in the user interface 208. The user may hold and select user interface 208 to save the image of the user interface 208 including the quote in memory of the mobile station 13a. In this way, the quote may be retrieved at a later time by the user of the mobile station 13a.

In some implementations, the user may accept the quote displayed in the user interface 208 by selecting an “Accept” button. In this scenario, the funds associated with the trade-in value may be automatically credited to the user's account associated with the wireless network provider. In some implementations, after the funds are credited or is there is any issue with credit of the funds another user interface may be displayed to the user that displays a confirmation number (or error code) of the transaction. The message may be displayed via a user interface that is provided in association with a bank associated with the user. The user interface may display the logo of the bank. The funds may then be applied by the user towards the purchase of a new mobile station. The purchase may be accomplished via another user interface that may be displayed after the user interface 208. The user interface may display images or videos of one or more mobile stations that may be available for purchase by the user based on the funds credited. The user may conveniently select one of the displayed images of the mobile stations to view a price of the mobile station(s) and may then select a “purchase” button to purchase a selected mobile station. This enhances user experience because a new device may be purchased right after trading-in the older mobile station 13a. The user may choose to ship the older mobile station 13a back to the wireless network provider to complete a trade-in. The new device may be automatically shipped by the wireless network provider after the user has selected the new device rather than waiting for the used device to arrive at a warehouse of the wireless network provider.

In some implementations where the user wants to discuss the trade-in value with a customer service agent, the user may share the user interface 208 (or its stored image) with a customer service agent of a wireless network provider. For example, the user may email the quote number to a customer service agent or call a customer service agent to provide the quote number.

FIG. 3 includes exemplary interfaces that can be used by a customer service agent to complete a trade-in process for the user of the mobile station 13a. A user interface 302 may be used by the customer service agent to retrieve a quote associated with a particular quote number.

The customer service agent may provide a quote number in the “Quick Search” input area of the user interface 302. A user interface 304 may be displayed when the quote number is provided via the user interface 302. The user interface 304 may display an overview of the questions answered by the user via the user interface 206 of FIG. 2. The user interface 304 may also display the trade-in value provided to the user via the user interface 208. The customer service agent may confirm the details of the appraisal displayed in a user interface 306 with the user. The confirmation may be done via phone, email or any other communication method. The customer service agent may ask the user to provide pictures of the mobile station 13a that is being traded-in to perform a preliminary visual inspection of the mobile station 13a. After the mobile station is received at a facility of a wireless network provider, the mobile station 13a may be further tested for operation of internal components an additional visual inspection may be performed. Once details of the appraisal have been confirmed with the user of the mobile station 13a, the customer service agent may provide a gift card number displayed in user interface 308. The gift card number may be redeemed by the user of the mobile station 13a at a store of a wireless network provider to purchase a new mobile station.

The enhanced device appraisal service under consideration here may be delivered to touch screen type mobile stations as well as to non-touch type mobile stations. Hence, our simple example shows the mobile station (MS) 13a as a non-touch type mobile station and shows the mobile station (MS) 13 as a touch screen type mobile station. Implementation of the on-line device appraisal service will involve at least some execution of programming in the mobile stations as well as implementation of user input/output functions and data communications through the network 15, from the mobile stations.

Those skilled in the art presumably are familiar with the structure, programming and operations of the various types of mobile stations. However, for completeness, it may be useful to consider the functional elements/aspects of two exemplary mobile stations 13a and 13b, at a high-level.

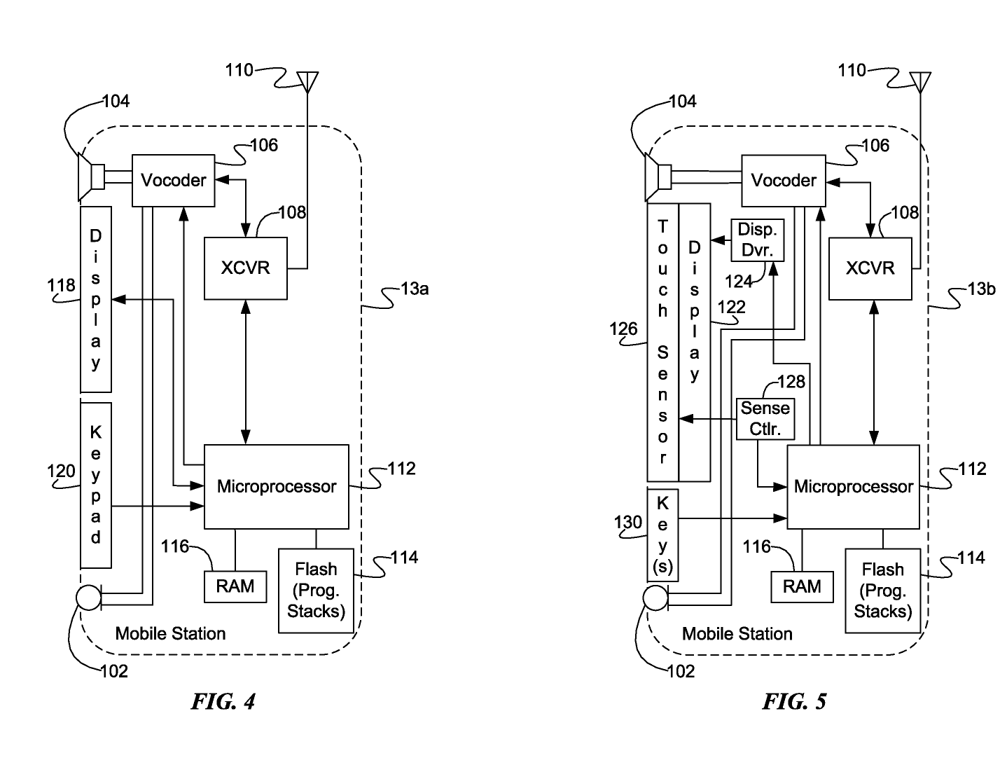

For purposes of such a discussion, FIG. 4 provides a block diagram illustration of an exemplary non-touch type mobile station 13a. Although the mobile station 13a may be a smart-phone or may be incorporated into another device, such as a personal digital assistant (PDA) or the like, for discussion purposes, the illustration shows the mobile station 13a is in the form of a handset. The handset embodiment of the mobile station 13a functions as a normal digital wireless telephone station. For that function, the station 13a includes a microphone 102 for audio signal input and a speaker 104 for audio signal output. The microphone 102 and speaker 104 connect to voice coding and decoding circuitry (vocoder) 106. For a voice telephone call, for example, the vocoder 106 provides two-way conversion between analog audio signals representing speech or other audio and digital samples at a compressed bit rate compatible with the digital protocol of wireless telephone network communications or voice over packet (Internet Protocol) communications.

For digital wireless communications, the handset 13a also includes at least one digital transceiver (XCVR) 108. Today, the handset 13a would be configured for digital wireless communications using one or more of the common network technology types. The concepts discussed here encompass embodiments of the mobile station 13a utilizing any digital transceivers that conform to current or future developed digital wireless communication standards. The mobile station 13a may also be capable of analog operation via a legacy network technology.

The transceiver 108 provides two-way wireless communication of information, such as vocoded speech samples and/or digital information, in accordance with the technology of the network 15. The transceiver 108 also sends and receives a variety of signaling messages in support of the various voice and data services provided via the mobile station 13a and the communication network. Each transceiver 108 connects through RF send and receive amplifiers (not separately shown) to an antenna 110. The transceiver may also support various types of mobile messaging services, such as short message service (SMS), enhanced messaging service (EMS) and/or multimedia messaging service (MMS).

The mobile station 13a includes a display 118 for displaying messages, menus or the like, call related information dialed by the user, calling party numbers, etc., including menus and user interface elements for the device appraisal service. A keypad 120 enables dialing digits for voice and/or data calls as well as generating selection inputs, for example, as may be keyed-in by the user based on a displayed menu or as a cursor control and selection of a highlighted item on a displayed screen. The display 118 and keypad 120 are the physical elements providing a textual or graphical user interface. Various combinations of the keypad 120, display 118, microphone 102 and speaker 104 may be used as the physical input output elements of the graphical user interface (GUI), for multimedia (e.g., audio and/or video) communications. Of course other user interface elements may be used, such as a trackball, as in some types of PDAs or smart phones.

In addition to normal telephone and data communication related input/output (including message input and message display functions), the user interface elements also may be used for display of menus and other information to the user and user input of selections, including any needed during device appraisal.

A microprocessor 112 serves as a programmable controller for the mobile station 13a, in that it controls all operations of the mobile station 13a in accord with programming that it executes, for all normal operations, and for operations involved in the device appraisal procedure under consideration here. In the example, the mobile station 13a includes flash type program memory 114, for storage of various “software” or “firmware” program routines and mobile configuration settings, such as mobile directory number (MDN) and/or mobile identification number (MIN), etc. The mobile station 13a may also include a non-volatile random access memory (RAM) 116 for a working data processing memory. Of course, other storage devices or configurations may be added to or substituted for those in the example. In a present implementation, the flash type program memory 114 stores firmware such as a boot routine, device driver software, an operating system, call processing software and vocoder control software, and any of a wide variety of other applications, such as client browser software and short message service software. The memories 114, 116 also store various data, such as telephone numbers and server addresses, downloaded data such as multimedia content, and various data input by the user. Programming stored in the flash type program memory 114, sometimes referred to as “firmware,” is loaded into and executed by the microprocessor 112.

As outlined above, the mobile station 13a includes a processor, and programming stored in the flash memory 114 configures the processor so that the mobile station is capable of performing various desired functions, including in this case the functions involved in the technique for providing device appraisal.

For purposes of such a discussion, FIG.5 provides a block diagram illustration of an exemplary touch screen type mobile station 13b. Although possible configured somewhat differently, at least logically, a number of the elements of the exemplary touch screen type mobile station 13b are similar to the elements of mobile station 13a, and are identified by like reference numbers in FIG. 3. For example, the touch screen type mobile station 13b includes a microphone 102, speaker 104 and vocoder 106, for audio input and output functions, much like in the earlier example. The mobile station 13b also includes at least one digital transceiver (XCVR) 108, for digital wireless communications, although the handset 13b may include an additional digital or analog transceiver. The concepts discussed here encompass embodiments of the mobile station 13b utilizing any digital transceivers that conform to current or future developed digital wireless communication standards. As in the station 13a, the transceiver 108 provides two-way wireless communication of information, such as vocoded speech samples and/or digital information, in accordance with the technology of the network 15. The transceiver 108 also sends and receives a variety of signaling messages in support of the various voice and data services provided via the mobile station 13b and the communication network. Each transceiver 108 connects through RF send and receive amplifiers (not separately shown) to an antenna 110. The transceiver may also support various types of mobile messaging services, such as short message service (SMS), enhanced messaging service (EMS) and/or multimedia messaging service (MMS).

As in the example of station 13a, a microprocessor 112 serves as a programmable controller for the mobile station 13b, in that it controls all operations of the mobile station 13b in accord with programming that it executes, for all normal operations, and for operations involved in the device appraisal procedure under consideration here. In the example, the mobile station 13b includes flash type program memory 114, for storage of various program routines and mobile configuration settings. The mobile station 13b may also include a non-volatile random access memory (RAM) 116 for a working data processing memory. Of course, other storage devices or configurations may be added to or substituted for those in the example. Hence, outlined above, the mobile station 13b includes a processor, and programming stored in the flash memory 114 configures the processor so that the mobile station is capable of performing various desired functions, including in this case the functions involved in the technique for providing device appraisal.

In the example of FIG. 2, the user interface elements included a display and a keypad. The mobile station 13b may have a limited number of key 130, but the user interface functions of the display and keypad are replaced by a touchscreen display arrangement. At a high level, a touchscreen display is a device that displays information to a user and can detect occurrence and location of a touch on the area of the display. The touch may be an actual touch of the display device with a finger, stylus or other object, although at least some touchscreens can also sense when the object is in close proximity to the screen. Use of a touchscreen display as part of the user interface enables a user to interact directly with the information presented on the display.

Hence, the exemplary mobile station 13b includes a display 122, which the microprocessor 112 controls via a display driver 124, to present visible outputs to the device user. The mobile station 13b also includes a touch/position sensor 126. The sensor 126 is relatively transparent, so that the user may view the information presented on the display 122. A sense circuit 128 sensing signals from elements of the touch/position sensor 126 and detects occurrence and position of each touch of the screen formed by the display 122 and sensor 126. The sense circuit 128 provides touch position information to the microprocessor 112, which can correlate that information to the information currently displayed via the display 122, to determine the nature of user input via the screen.

The display 122 and touch sensor 126 (and possibly one or more keys 130, if included) are the physical elements providing the textual and graphical user interface for the mobile station 13b. The microphone 102 and speaker 104 may be used as additional user interface elements, for audio input and output, including with respect to some device appraisal related functions.

The structure and operation of the mobile stations 13a and 13b, as outlined above, were described to by way of example, only.

As shown by the above discussion, functions relating to an enhanced experience for the device appraisal service, via a graphical user interface of a mobile station may be implemented on computers connected for data communication via the components of a packet data network, operating as an appraisal server as shown in FIG. 1. Although special purpose devices may be used, such devices also may be implemented using one or more hardware platforms intended to represent a general class of data processing device commonly used to run “server” programming so as to implement the device appraisal functions discussed above, albeit with an appropriate network connection for data communication.

As known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data, e.g. files used for device appraisal. The software code is executable by the general-purpose computer that functions as the appraisal server and/or that functions as a mobile station. In operation, the code is stored within the general-purpose computer platform. At other times, however, the software may be stored at other locations and/or transported for loading into the appropriate general-purpose computer system. Execution of such code by a processor of the computer platform enables the platform to implement the methodology for device appraisal in essentially the manner performed in the implementations discussed and illustrated herein.

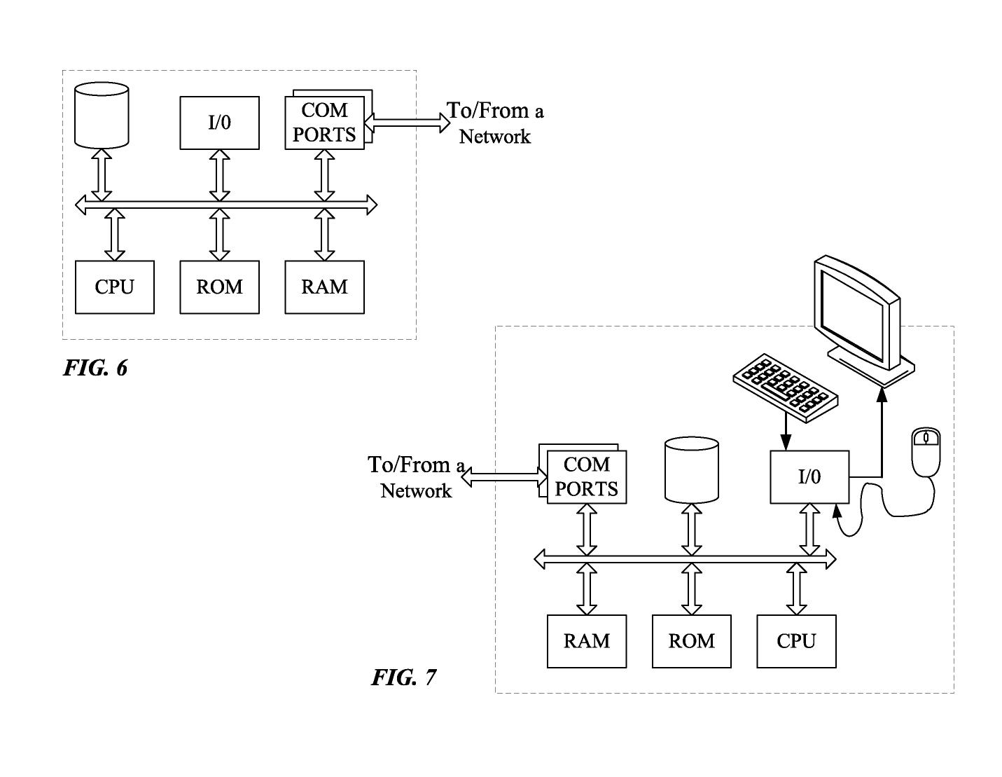

FIGS. 6 and 7 provide functional block diagram illustrations of general purpose computer hardware platforms. FIG. 6 illustrates a network or host computer platform, as may typically be used to implement a server. FIG. 7 depicts a computer with user interface elements, as may be used to implement a personal computer or other type of work station or terminal device, although the computer of FIG. 7 may also act as a server if appropriately programmed. It is believed that those skilled in the art are familiar with the structure, programming and general operation of such computer equipment and as a result the drawings should be self-explanatory.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature, and it is presumed that those skilled in the art are adequately familiar therewith. Of course, the server functions may be implemented in a distributed fashion on a number of similar platforms, to distribute the processing load.

A computer type user terminal device, such as a PC or tablet computer, similarly includes a data communication interface CPU, main memory and one or more mass storage devices for storing user data and the various executable programs (see FIG. 7). A mobile device type user terminal may include similar elements, but will typically use smaller components that also require less power, to facilitate implementation in a portable form factor. The various types of user terminal devices will also include various user input and output elements. A computer, for example, may include a keyboard and a cursor control/selection device such as a mouse, trackball, joystick or touchpad; and a display for visual outputs. A microphone and speaker enable audio input and output. Some smartphones include similar but smaller input and output elements. Tablets and other types of smartphones utilize touch sensitive display screens, instead of separate keyboard and cursor control elements. The hardware elements, operating systems and programming languages of such user terminal devices also are conventional in nature, and it is presumed that those skilled in the art are adequately familiar therewith.

Hence, aspects of the methods of device appraisal outlined above may be embodied in programming. Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of a wireless network provider into the computer platform of the appraisal server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the device appraisal, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
receiving, via a network, a request from a mobile station at an appraisal server to access a device appraisal service;
upon receipt of the request at the appraisal server, retrieving at the appraisal sever one or more parameters associated with the mobile station, wherein the parameters include at least a mobile directory number (MDN) of the mobile station;
automatically determining at the appraisal server a model of the mobile station based on the MDN;
providing for display in a web interface an identification of the model of the mobile station and one or more user interface elements to receive condition information of the mobile station;
receiving the condition information of the mobile station at the appraisal server via the user interface elements in the web interface;
upon receiving the condition information of the mobile station at the appraisal server, determining a trade-in value of the mobile station based on the identified model and the condition information; and
providing, from the appraisal server, the trade-in value of the mobile station to the web interface for display at the mobile station.

2. The method of claim 1, further comprising:
determining a quote identification number for the determined trade-in value of the mobile station;
generating a representation of the quote number, wherein the representation includes a visual representation code or a representation including one or more near field communication (NFC) interactions; and
providing the representation of the quote number for display at the web interface with the determined trade-in value.

3. The method of claim 1, wherein the one or more user interface elements include selection buttons indicative of yes or no responses to one or more condition questions regarding physical appearance of the mobile station.

4. The method of claim 1, wherein the questions relate to exterior visual, internal hardware or software aspects of the mobile station.

5. The method of claim 1 wherein a search interface is displayed via the web interface to allow the user to search for the model of the mobile station when the determining of the model of the mobile station fails.

6. The method of claim 5, further comprising:
providing for display, at the web interface, a list of mobile station models from a catalog of mobile stations after receiving an acceptance of the trade-in value of the mobile station; and
receiving a selection of a particular mobile station model from the displayed list .

7. An appraisal server comprising:
a communication interface configured to enable communication via a mobile network;
a processor coupled with the communication interface;
a storage device accessible to the processor; and
an executable program in the storage device, wherein execution of the program by the processor configures the server to perform functions, including functions to:
receive, via a network, a request from a mobile station at the appraisal server to access a device appraisal service;
upon receipt of the request at the appraisal server, retrieve one or more parameters associated with the mobile station, wherein the parameters include at least a mobile directory number (MDN) of the mobile station;
automatically determine at the appraisal server a model of the mobile station based on the MDN;
provide for display in a web interface an identification of the model of the mobile station and one or more user interface elements to receive condition information of the mobile station;
receive, at the appraisal server, the condition information of the mobile station via the user interface elements in the web interface;
upon receiving the condition information of the mobile station at the appraisal server, determine a trade-in value of the mobile station based on the identified model and the condition information; and
provide, from the appraisal server, the trade-in value of mobile station to the web interface for display at the mobile station.

8. The appraisal server of claim 7, wherein execution of the program by the processor configures the appraisal server to perform functions, including functions to:
determining a quote identification number for the determined trade-in value of the mobile station;
generating a representation of the quote number, wherein the representation includes a visual representation code or a representation including one or more near field communication (NFC) interactions; and
providing the representation of the quote number for display at the web interface with the determined trade-in value.

9. The appraisal server of claim 7, wherein the determining of the trade-in value includes functions to:
identify in a database table the model and the condition information of the mobile station; and
identify a trade-in value corresponding to the model and the condition information of the mobile station.

10. The appraisal server of claim 7, wherein the one or more user interface elements include selection buttons indicative of yes or no responses to one or more condition questions regarding physical appearance of the mobile station.

11. The appraisal server of claim 10, wherein the questions relate to exterior visual, internal hardware or software aspects of the mobile station.

12. The appraisal server of claim 7, wherein a search interface is displayed via the web interface to allow the user to search for the model of the mobile station when the determining of the model of the mobile station fails.

13. The appraisal server of claim 12, wherein execution of the program by the processor configures the appraisal server to perform functions, including functions to:
provide for display a list of mobile station models from a catalog of mobile stations; and
receive a selection of a particular mobile station model from the displayed list.

14. The appraisal server of claim 7, wherein execution of the program by the processor configures the appraisal server to perform functions, including functions to:
transmit the retrieved parameters including the MDN to a messaging service, wherein the messaging service generates messaging service messages for the device appraisal service;
provide a request to the user to confirm enrollment in the device appraisal service;
receive, in response to the request, an indication from the mobile station indicating approval to receive a messaging service message from the messaging service, the messaging service message including a link to access a web interface of the device appraisal service; and
transmit, to the MDN of the mobile station, the messaging service message including the link to access the web interface of the device appraisal service.

15. A non-transitory computer-readable medium comprising instructions which, when executed by one or more computers, cause the one or more computers to:
receive, via a network, a request from a mobile station at the appraisal server to access a device appraisal service;
upon receipt of the request at the appraisal server, retrieve one or more parameters associated with the mobile station, wherein the parameters include at least a mobile directory number (MDN) of the mobile station;
automatically determine at the appraisal server a model of the mobile station based on the MDN;
provide for display in a web interface an identification of the model of the mobile station and one or more user interface elements to receive condition information of the mobile station;
receive, at the appraisal server, the condition information of the mobile station via the user interface elements in the web interface;
upon receiving the condition information of the mobile station at the appraisal server, determine a trade-in value of the mobile station based on the identified model and the condition information; and
provide, from the appraisal server, the trade-in value of mobile station to the web interface for display at the mobile station.

16. The computer-readable medium of claim 15 further comprising instructions which, when executed by the one or more computers, cause the one or more computers to:
determine a quote identification number for the determined trade-in value of the mobile station;
generate a representation of the quote number, wherein the representation includes a visual code or a representation including one or more near field communication (NFC) interactions; and
provide the representation of the quote number for display at the web interface with the determined trade-in value.

17. The computer-readable medium of claim 15 further comprising instructions which, when executed by the one or more computers, cause the one or more computers to:
identify in a database table the model and the condition information of the mobile station; and
identify a trade-in value corresponding to the model and the condition information of the mobile station.

18. The computer-readable medium of claim 15 wherein the one or more user interface elements include selection buttons indicative of yes or no responses to one or more condition questions regarding physical appearance of the mobile station.

19. The computer-readable medium of claim 15 further comprising instructions which, when executed by the one or more computers, cause the one or more computers to:
transmit the retrieved parameters including the MDN to a messaging service, wherein the messaging service generates messaging service messages for the device appraisal service;
provide a request to the user to confirm enrollment in the device appraisal service;
receive, in response to the request, an indication from the mobile station indicating approval to receive a messaging service message from the messaging service, the messaging service message including a link to access a web interface of the device appraisal service; and
transmit, to the MDN of the mobile station, the messaging service message including the link to access the web interface of the device appraisal service.

20. The computer-readable medium of claim 15 wherein a search interface is displayed via the web interface to allow the user to search for the model of the mobile station when the determining of the model of the mobile station fails.
